(19) United States
(12) Patent Application Publication
(10) Pub. No.: US 2013/0169122 A1
(43) Pub. Date: Jul. 4, 2013

(54) CONNECTOR MOUNTING APPARATUS

(71) Applicants: ZHI-MING ZHU, WUHAN CITY (CN); TING WANG, WUHAN CITY (CN)

(72) Inventors: ZHI-MING ZHU, WUHAN CITY (CN); TING WANG, WUHAN CITY (CN)

(21) Appl. No.: 13/648,523

(22) Filed: Oct. 10, 2012

(30) Foreign Application Priority Data
Dec. 28, 2011 (CN) 201110447065.7

(51) Int. Cl. H01R 13/502

(52) U.S. Cl. 312/223.1

(57) ABSTRACT

A connector mounting apparatus includes a receiving member and a securing member. The receiving member includes a base panel and a plurality of securing portions. Each securing portion includes a recess portion and an engaging protrusion extending from a bottom surface of the recess portion. The securing member includes a mounting panel and a plurality of securing tabs. Each securing tab defines an engaging opening. Each securing tab is received in the recess portion to enable the engaging opening to engage with the engaging protrusion, thereby surrounding a connector between the base panel and the mounting panel.

### BACKGROUND

1. Technical Field

The disclosure generally relates to mounting apparatus, especially, to a mounting apparatus for connectors.

2. Description of Related Art

A computer usually includes a mounting apparatus for mounting connectors. The mounting apparatus includes two plastic parts. The two plastic parts are melted together to secure connectors therebetween. However, during the melting process, the two plastic parts are melted together via a tool, it is very inconvenient to assemble the connectors.

Thus, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a connector mounting apparatus.

FIG. 2 is similar to FIG. 1, but viewed from another aspect.

FIG. 3 is a view of an assembled connector mounting apparatus of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

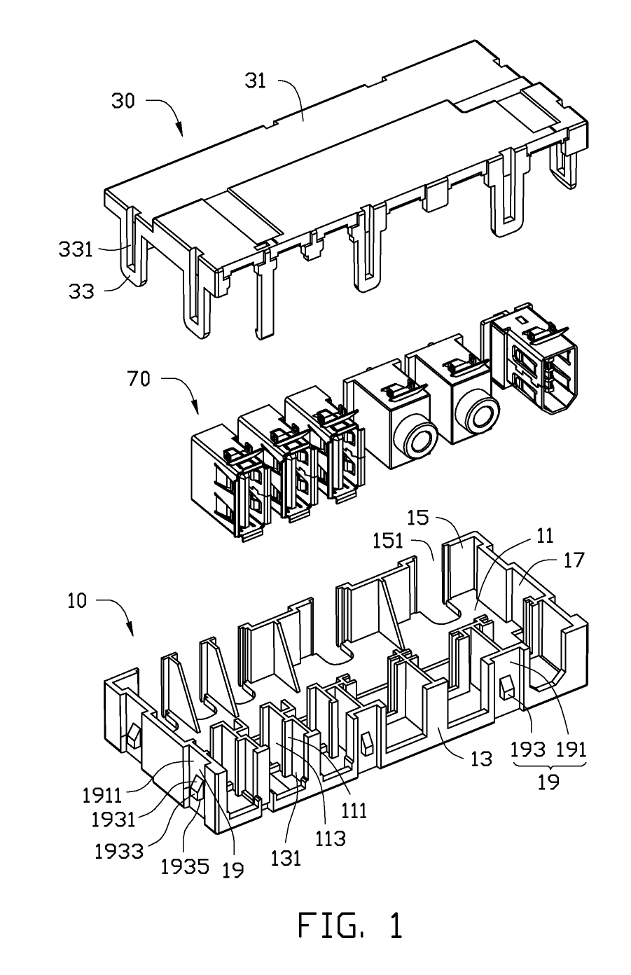

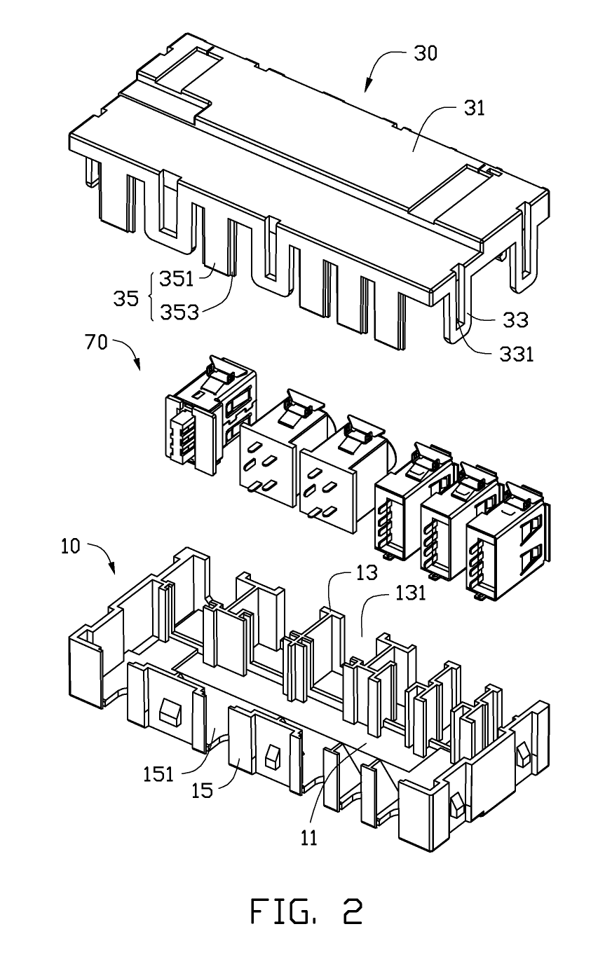

Referring to FIGS. 1 and 2, one embodiment of a connector mounting apparatus is shown. The connector mounting apparatus includes a receiving member 10 and a securing member 30. The connector mounting apparatus is used for mounting a plurality of connectors 70. In one embodiment, the plurality of connectors 70 are USB connectors and audio connectors.

The receiving member 10 includes a base panel 11, a front panel 13, perpendicularly extending from the base panel 11; a rear panel 15, perpendicularly extending from the base panel 11; and two side panels 17, perpendicularly extending from the base panel 11. The front panel 13 is substantially parallel to the rear panel 15. The two side panels 17 are substantially parallel to each other and are connected between the rear panel 15 and the front panel 13. The front panel 13 defines a plurality of receiving openings 131. The receiving member 10 further includes receiving portions 111 extending from the base panel 11 and corresponding to the receiving openings 131. Each receiving portion 111 defines a receiving space 113 communicating with one receiving opening 131. The receiving space 113 is used for receiving one connector 70. The receiving member 10 further includes a plurality of securing portions 19 extending from the front panel 13, the rear panel 15, and the side panels 17. Each securing portion 19 includes a recess portion 191 and an engaging protrusion 193. The recess portion 191 defines a bottom surface 1911. The engaging protrusion 193 extends from the bottom surface 1911. The engaging protrusion 193 comprises an inclining surface 1931 connected to the bottom surface 1911, a connecting surface 1933 connected to the inclining surface 1931, and an engaging surface 1935 connected to the connecting surface 1933. The connecting surface 1933 is substantially parallel to the bottom surface 1911. The engaging surface 1935 is substantially perpendicular to the bottom surface 1911. The rear panel 15 defines a plurality of positioning openings 151.

The securing member 30 includes a mounting panel 31 substantially parallel to the base panel 11, a plurality of securing tabs 33 extending from the mounting panel 31, and a plurality of positioning tabs 35 extending from the mounting panel 31. The securing tab 33 defines an engaging opening 331 corresponding to the engaging protrusion 193. Each positioning tab 35 includes a positioning body 351 and two resisting ends 353 extending from opposite sides of the positioning body 351. The width of the positioning body 351 is greater than the width of the resisting end 353, taken along a plane substantially perpendicular to the rear panel 15. The positioning body 351 is received in the positioning opening 151, and the corresponding resisting ends 353 resist the two sides of the positioning opening 151.

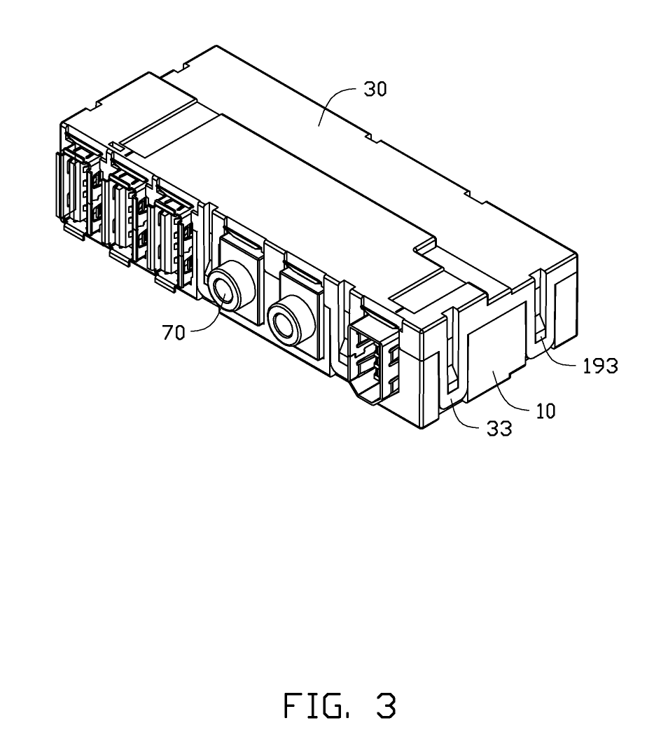

Referring to FIGS. 1 to 3, in assembly, the connectors 70 are placed in the receiving spaces 113 of the receiving member 10. The securing tabs 33 and the positioning tabs 35 of the securing member 30 are aligned with the securing portions 19 and the positioning openings 151. The securing member 30 moves towards the receiving member 10 to enable the securing tabs 33 to resist the bottom surfaces 1911 of the recess portions 191 of the securing portions 19. The securing tabs 33 are deformed when resisting the inclining surfaces 1931 of the securing portions 19. The securing member 30 continues to move to enable the engaging openings 331 to be aligned with the engaging surfaces 1935. The securing tabs 33 release to enable the engaging openings 331 to engaging with the engaging protrusions 193. At this time, each positioning body 351 of the positioning tab 35 is received in the positioning opening 151, and the corresponding resisting ends 353 resist opposite sides of the positioning opening 151. The connectors 70 are located between the mounting panel 31 and the base panel 11.

It is to be understood, however, that even though numerous characteristics and advantages have been set forth in the foregoing description of embodiments, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A connector mounting apparatus, comprising:
a receiving member, the receiving member comprises a base panel and a plurality of securing portions; and each securing portion comprises a recess portion and an engaging protrusion, extending from a bottom surface of the recess portion; and
a securing member, the securing member comprises a mounting panel and a plurality of securing tabs; each securing tab defines an engaging opening; each securing tab is configured to be received in the recess portion to enable the engaging opening to engage with the engaging protrusion, thereby securing a connector to be located between the base panel and the mounting panel.

2. The connector mounting apparatus of claim 1, wherein the engaging protrusion defines an inclining surface, connected to the bottom surface; a connecting surface, connected to the inclining surface; and an engaging surface connected to the connecting surface; wherein the inclining surface is configured to guide the securing tab to move toward the engaging surface to enable the engaging surface to be engaged in the engaging opening.

3. The connector mounting apparatus of claim 2, wherein the engaging surface is substantially perpendicular to the bottom surface.

4. The connector mounting apparatus of claim 2, wherein the connecting surface is substantially parallel the bottom surface.

5. The connector mounting apparatus of claim 1, wherein the receiving member further comprises a front panel extending from the base panel, and the front panel is substantially perpendicular to the base panel; and the front panel defines a receiving opening used for exposing the connector out of the receiving member.

6. The connector mounting apparatus of claim 5, wherein the receiving member further comprises a receiving portion extending from the base panel; the receiving portion defines a receiving space communicated with the receiving opening; and the receiving space is used for receiving the connector.

7. The connector mounting apparatus of claim 5, wherein the receiving member further comprises a rear panel extending from the base panel; the rear panel defines a positioning opening; the securing member further comprises a positioning tab extending from the mounting panel; the positioning tab comprises a positioning body and two resisting ends extending from opposite sides of the positioning body; and the positioning body is received in the positioning opening and the two resisting ends resist two sides of the positioning opening.

8. The connector mounting apparatus of claim 7, wherein the rear panel is substantially parallel to the front panel.

9. The connector mounting apparatus of claim 1, wherein the base panel is substantially parallel to the mounting panel.

10. A connector mounting apparatus, comprising:
a receiving member, the receiving member comprises a base panel, a front panel extending from the base panel, a plurality of securing portions, and a receiving portion extending from the base panel; the receiving portion defines a receiving space for receiving a connector; and the front panel defines a receiving opening communicating with the receiving space; and
a securing member, the securing member comprises a mounting panel and a plurality of securing tabs; each securing tab engages with one of the plurality of securing portions to enable the connector to be located between the base panel and the mounting panel and expose the connector out of the front panel via the receiving opening.

11. The connector mounting apparatus of claim 10, wherein each securing portion comprises a recess portion and an engaging protrusion extending from a bottom surface of the recess portion; each securing tab defines an engaging opening; and each securing tab is configured to be received in the recess portion to enable the engaging opening to engage with the engaging protrusion.

12. The connector mounting apparatus of claim 11, wherein the engaging protrusion defines an inclining surface connected to the bottom surface, a connecting surface connected to the inclining surface, and an engaging surface connected to the connecting surface; the inclining surface is configured to guide the securing tab to move toward the engaging surface to enable the engaging surface to be engaged in the engaging opening.

13. The connector mounting apparatus of claim 12, wherein the engaging surface is substantially perpendicular to the bottom surface.

14. The connector mounting apparatus of claim 12, wherein the connecting surface is substantially parallel the bottom surface.

15. The connector mounting apparatus of claim 10, wherein the front panel is substantially perpendicular to the base panel.

16. The connector mounting apparatus of claim 15, wherein the receiving member further comprises a rear panel extending from the base panel; the rear panel defines a positioning opening; the securing member further comprises a positioning tab extending from the mounting panel; the positioning tab comprises a positioning body and two resisting ends extending from opposite sides of the positioning body; and the positioning body is received in the positioning opening and the two resisting ends resist two sides of the positioning opening.

17. The connector mounting apparatus of claim 16, wherein the rear panel is substantially parallel to the front panel.

18. The connector mounting apparatus of claim 10, wherein the base panel is substantially parallel to the mounting panel.
